(19) United States
(12) Patent Application Publication
(10) Pub. No.: US 2007/0088986 A1
(43) Pub. Date: Apr. 19, 2007

(54) Systems and methods for testing software code

(75) Inventors: Gavin Stark, St. Petersburg, FL (US); Michael G. Johnson, Lutz, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/253,500

(22) Filed: Oct. 19, 2005

(51) Int. Cl. G06F 11/00

(52) U.S. Cl. 714/32

(57) ABSTRACT

Systems and methods for testing software code are provided. In one embodiment, a method for evaluating a test code is provided. The method comprises associating one or more unique software component identifiers with one or more components within a software application; compiling a first table that comprises the one or more unique software component identifiers associated with each of one or more components of the software application; inserting one or more correlation tags into a test code, wherein the test code includes one or more test procedures adapted to verify the software application; compiling a second table that identifies one or more of the one or more components within the software application tested by the one or more test procedures, based on the one or more correlation tags; and cross correlating the first table and the second table to determine one or more test metrics.

### TECHNICAL FIELD

The present invention generally relates to software and more specifically to testing software code.

### BACKGROUND

When software code is developed, it must be tested to ensure that it will function as expected. Typically, individual components of the software code are tested against one or more test methodologies, such as, but not limited to, min/max testing, boundary testing, stress testing, permutation testing, invalid value testing, thread-safety testing, and timing testing. These test methodologies are themselves accomplished through the execution of test code. A challenge that arises is ensuring that each component of the software code under test is tested by the one or more test methodologies of the test code. Often, line coverage or path coverage tools are used to obtain these metrics, but their usage is typically difficult, cumbersome and can lead to instances of false positives.

For the reasons stated above and for other reasons stated below which will become apparent to those skilled in the art upon reading and understanding the specification, there is a need in the art for improved systems and methods for testing software code.

### SUMMARY

The Embodiments of the present invention provide methods and systems for testing software code and will be understood by reading and studying the following specification.

In one embodiment, a method for evaluating a test code is provided. The method comprises associating one or more unique software component identifiers with one or more components within a software application; compiling a first table that comprises the one or more unique software component identifiers associated with each of one or more components of the software application; inserting one or more correlation tags into a test code, wherein the test code includes one or more test procedures adapted to verify the software application; compiling a second table that identifies one or more of the one or more components within the software application tested by the one or more test procedures, based on the one or more correlation tags; and cross correlating the first table and the second table to determine one or more test metrics.

In another embodiment, a system for deriving test metrics for test code is provided. The system comprises a first parser adapted to read a software application having one or more components and identify a unique software component identifier associated with each of the one or more components, wherein the first parser is further adapted to output a first table that lists the unique software component identifier associated with each of the one or more components; a test code including one or more test procedures and one or more correlation tags, wherein a first test procedure of the one or more test procedures is adapted to test a first component of the one or more components based on one or more test methodologies, and wherein the first procedure includes a first correlation tag of the one or more correlation tags; and a second parser adapted to read the test code, wherein the second parser is further adapted to output a second table based on the one or more correlation tags; wherein the second table includes the unique software component identifier associated with each of one or more components of the software application tested by the test code.

In yet another embodiment, a system for deriving test metrics for test code is provided. The system comprises means for reading a software code for a software application having one or more components; means for compiling a first table that associates a unique software component identifier with each of the one or more components of the software application, the means for compiling a first table responsive to the means for reading the software code; means for reading a test code having one or more test procedures adapted to test the software application based on one or more test methodologies, the test code further having one or more correlation tags, wherein the correlation tags each include one or both of the unique software component identifier associate with a component of the one or more components tested by the test code, and a test methodology; means for compiling a second table based on the one or more correlation tags, wherein the second table identifies one or both of which of the one or more components are tested by each of the one or more test procedures and which of the one or more test methodologies are applied by each of the one or more test procedures, the means for compiling a second table responsive to the means for reading the test code; and means for cross correlating the first table and the second table to determine one or more test metrics, the means for cross correlating responsive to the means for compiling a first table and the means for compiling a second table.

In yet another embodiment, a computer-readable medium having computer-executable instructions for performing a method for evaluating a test code is provided. The method comprises compiling a first table that comprises one or more unique software component identifiers associated with one or more components of a software application; compiling a second table based on one or more correlation tags, wherein the second table identifies one or more of the one or more components of the software application tested by a test code, wherein the test code includes one or more test procedures adapted to verify the software application, and wherein the test code further includes the one or more correlation tags; and cross correlating the first table and the second table to determine one or more test metrics.

### DRAWINGS

Embodiments of the present invention can be more easily understood and further advantages and uses thereof more readily apparent, when considered in view of the description of the preferred embodiments and the following figures in which:

FIGS. 1A-1C illustrate a system for evaluating a test code of one embodiment of the present invention; and

FIG. 2 is a flow chart illustrating a method for evaluating a test code of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiment of the present invention address the problem of ensuring that each component of a software application is tested against each of one or more desired test methodologies by inserting one or more correlation tags within test code used to verify the software application. By incorporating a unique software component identifier within each correlation tag, a number of test metrics are derived including, but not limited to: a) components of the software application that are not tested, b) components of the software application tested more than once, c) variations of test methodologies applied to the each component of the software application, d) a source line of code ratio for each component of the software application, and e) an estimate of the complexity and the costs of testing the software application.

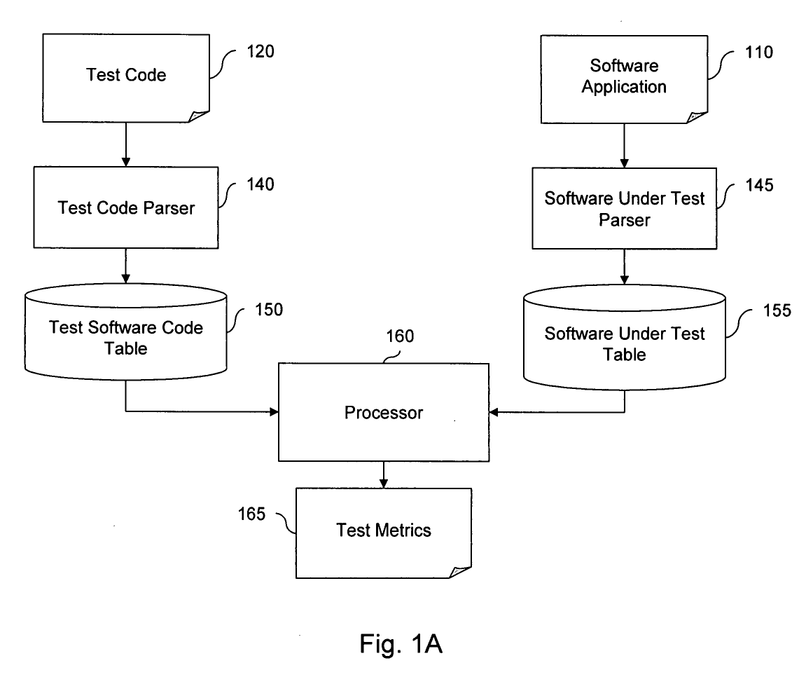

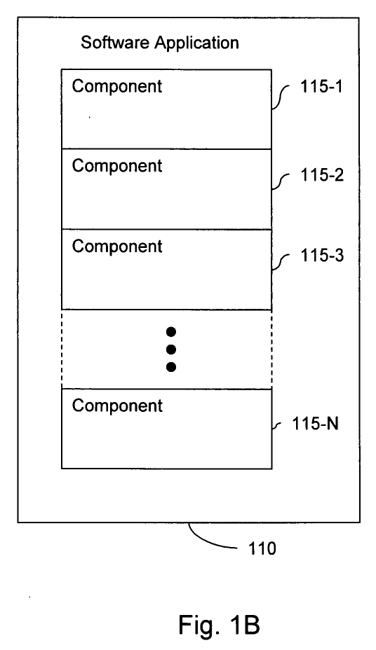

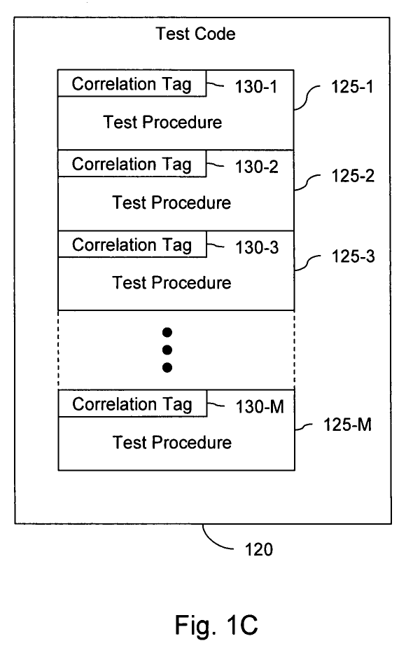

FIG. 1A through 1C illustrate a system 100 for evaluating a test code 120 used to verify a software application 110. As illustrated in FIG. 1A, system 100 comprises test code 120, a test code parser 140, a test software code table 150, software application 110, software under test parser 145, and software under test table 155.

Software application 110 includes a plurality of components 115-1 to 115-N, as illustrated by FIG. 1B. The composition of components 115-1 to 115-N will vary depending on the programming language used to code software application 110. For example, components 115-1 to 115-N may each comprise one of a function, a class, a method, an object, a structure, a data signature, a subroutine, or similar software component. In order to verify the functionality of each of components 115-1 to 115-N, test code 120 includes a plurality of test procedures 125-1 to 125-M, as illustrated by FIG. 1C. Test procedures 125-1 to 125-M each comprise software code for testing one or more of components 115-1 to 115-N based on one or more test methodologies. When test code 120 is executed by a computer (not shown), the computer will execute the one or more test procedures to apply the one or more test methodologies and verify the functionality of one or more of components 115-1 to 115-N. In one embodiment, test methodologies implemented by one or more of test procedures 125-1 to 125-M include, but are not limited to min/max testing, boundary testing, stress testing, permutation testing, invalid value testing, thread-safety testing, and timing testing.

In order to cross-correlate test procedures 125-1 to 125-M with components 115-1 to 115-N, embodiments of the present invention assign each component 115-1 to 115-N of software application 110 with a unique software component identifier. No two components 115-1 to 115-N of software application 110 will share the same unique software component identifier. Embodiments of the present invention further insert correlation tags 130-1 to 130-M within the code of test procedures 125-1 to 125-M. In one embodiment, within each procedure (e.g. procedure 125-1) an associated correlation tag (e.g., correlation tag 130-1) comprises a unique software component identifier that identifies which of components 115-1 to 115-N are tested by that procedure. In one embodiment, each correlation tag 130-1 to 130-M further identifies the test methodology that is executed by the associated test procedure 125-1 to 125-M.

As illustrated is FIG. 1A, in one embodiment in operation, software under test parser 145 inputs the code of software application 110, and parses the code in order to associate each component 115-1 to 115-N with a unique software component identifier. Based on the parsing, software under test parser 145 then outputs the software under test table 155, which lists the unique software component identifier for each component 115-1 to 115-N within software application 110.

In one embodiment in operation, test code parser 140 reads test code 120 and identifies each correlation tag 130-1 to 130-M associated with each test procedure 125-1 to 125-M. Based on the identified correlation tags 130-1 to 130-M, test code parser 140 outputs test software code table 150. In one embodiment, test software code table 150 comprises a list identifying the unique software component identifier extracted from correlation tags 130-1 to 130-M. Thus, test software code table 150 identifies every component 115-1 to 115-N within software application 110 that is tested by test code 120. In one embodiment, test code parser 140 extracts from correlation tags 130-1 to 130-M the unique software component identifier and the test methodology for each test procedure 125-1 to 125-M and outputs that information into test software code table 150.

By cross-correlating the unique software component identifiers contained within test software code table 150 and software under test table 155, the completeness and scope of the functional testing performed by test code 120 on software application 110 can be assessed. In one embodiment, system 100 optionally comprises a correlation function 160 configured to cross correlate the unique software component identifiers from test software code table 150 and software under test table 155 and output one or more test metrics 165. In one embodiment, test metrics 165 identify one or more of, but not limited to, which components 115-1 to 115-N of software application 110 are not tested by test code 120, which components 115-1 to 115-N of software application 110 are tested more than once by test code 120, which test methodologies are applied to each component 115-1 to 115-N of software application 110, a source line of code ratio for each component 115-1 to 115-N of software application 110, and provides information for estimating the complexity and costs of testing software application 110.

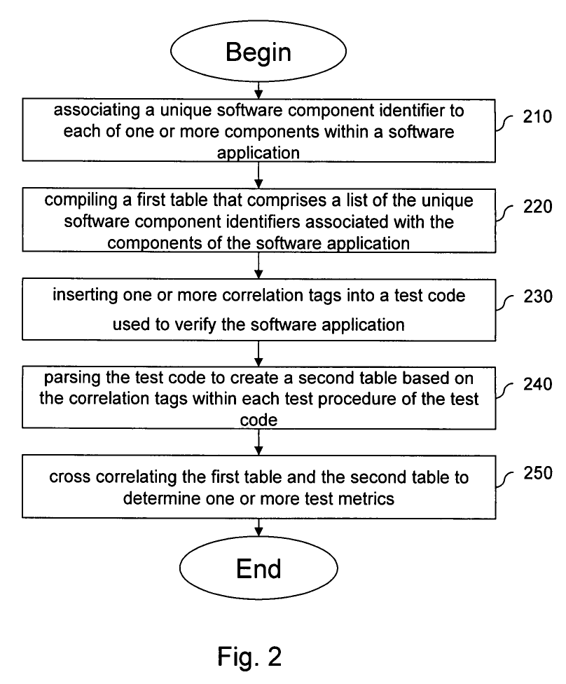

FIG. 2 is a flow chart illustrating a method for evaluating a test code used to verify a software application, of one embodiment of the present invention. The method begins at 210 with associating a unique software component identifier with each component of a software application. As previously discussed, the composition of components will vary depending on the programming language used to code the software application. For example, a component may comprise one of a function, a class, a method, an object, a structure, a data signature, a subroutine, or similar software programming technique. The method continues at 220 with compiling a first table that comprises a list of the unique software component identifiers associated with components of the software application. The method proceeds to 230 with inserting one or more correlation tags into a test code that will be used to verify the software application. In one embodiment, where the test code comprises one or more testing procedures, a correlation tag is inserted into each testing procedure. In one embodiment, the correlation tag identifies the unique software component identifier of the software application component that is verified by that testing procedure. In one embodiment, the correlation tag further identifies the test methodology that is implemented by the testing procedure. In one embodiment, the test methodology implemented by the test procedure includes one or more of, min/max testing, boundary testing, stress testing, permutation testing, invalid value testing, thread-safety testing, and timing testing. The method continues at 240 with parsing the test code to create a second table that, based on the correlation tags within each test procedure, identifies one or both of the unique software component identifier of the software application component tested by the procedure, and the test methodology implemented by the procedure. The method proceeds to 250 with cross correlating the first table and the second table to determine one or more test metrics. In one embodiment, the test metrics provide one or more of, but not limited to, which components of the software application are not tested by the test code, which components of the software application are tested more than once by the test code, which test methodologies are applied to each component of the software application a source line of code ratio for each component of the software application, and further provides information for estimating the complexity and costs of testing the software application.

Several means are available to implement the test code parser, the test software code table, the software under test parser, the software under test table, and the correlation function discussed with respect to embodiments of the current invention. These means include, but are not limited to, digital computer systems, programmable controllers, or field programmable gate arrays. Therefore other embodiments of the present invention are program instructions resident on computer readable media which when implemented by such processors, enable the processors to implement embodiments of the present invention. Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for evaluating a test code, the method comprising:
associating one or more unique software component identifiers with one or more components within a software application;
compiling a first table that comprises the one or more unique software component identifiers associated with each of one or more components of the software application;
inserting one or more correlation tags into a test code, wherein the test code includes one or more test procedures adapted to verify the software application;
compiling a second table that identifies one or more of the one or more components within the software application tested by the one or more test procedures, based on the one or more correlation tags; and
cross correlating the first table and the second table to determine one or more test metrics.

2. The method of claim 1, wherein compiling the first table further comprises parsing the software application.

3. The method of claim 1, wherein compiling the second table further comprises parsing the test code based on the correlation tags.

4. The method of claim 1, wherein inserting one or more correlation tags further comprises inserting a first unique software component identifier of the one or more unique software component identifiers associated with a first component of the one or more components into a first test procedure of the one or more test procedures.

5. The method of claim 4, wherein inserting one or more correlation tags further comprises inserting an identifier into the first test procedure of the one or more test procedures that identifies a first test methodology of one or more test methodologies implemented by the first test procedure.

6. The method of claim 5, wherein inserting an identifier into the first test procedure of the one or more test procedures further comprises identifying one or more of, a min/max test methodology, a boundary test methodology, a stress test methodology, a permutation test methodology, an invalid value test methodology, a thread-safety test methodology, and a timing test methodology.

7. The method of claim 1, wherein compiling the second table further comprises identifying one or more test methodologies implemented by each of the one or more test procedures.

8. The method of claim 1, wherein inserting one or more correlation tags into the test code further comprises inserting at least one correlation tag into each of the one or more testing procedures.

9. The method of claim 1, further comprising one or more of:
identifying untested components of the one or more components within the software application;
identifying components of the one or more components that are tested more than once by the test code;
identifying which test methodologies are applied to each of the one or more components;
determining a source line of code ratio for each component of the one or more components; and
determining one or both of a complexity and a costs of testing the software application.

10. A system for deriving test metrics for test code, the system comprising:
a first parser adapted to read a software application having one or more components and identify a unique software component identifier associated with each of the one or more components, wherein the first parser is further adapted to output a first table that lists the unique software component identifier associated with each of the one or more components;
a test code including one or more test procedures and one or more correlation tags, wherein a first test procedure of the one or more test procedures is adapted to test a first component of the one or more components based on one or more test methodologies, and wherein the first procedure includes a first correlation tag of the one or more correlation tags; and
a second parser adapted to read the test code, wherein the second parser is further adapted to output a second table based on the one or more correlation tags; wherein the second table includes the unique software component identifier associated with each of one or more components of the software application tested by the test code.

11. The system of claim 10 wherein the second table further associates at least one test methodology of the one or more test methodologies with each of one or more components of the software application tested by the test code.

12. The system of claim 10 wherein the first correlation tag further comprises one or both of a first unique software component identifier associated with the first component, and a first test methodology of the one or more test methodologies.

13. The system of claim 10 further comprising:
a correlation function adapted to cross correlate the first table and the second table and output one or more test metrics based on the cross correlation.

14. The system of claim 13 wherein the one or more test metrics comprise one or more of:
which components of the one or more components are not tested by the test code;
which components of the one or more components are tested more than once by the test code;
which test methodologies of the one or more test methodologies are applied to each component of the one or more components;
a source line of code ratio for each component of the one or more components; and
information for estimating one or more of a complexity and a costs of testing the software application.

15. The system of claim 10 wherein the one or more test methodologies include one or more of min/max testing, boundary testing, stress testing, permutation testing, invalid value testing, thread-safety testing, and timing testing.

16. A system for deriving test metrics for test code, the system comprising
means for reading a software code for a software application having one or more components;
means for compiling a first table that associates a unique software component identifier with each of the one or more components of the software application, the means for compiling a first table responsive to the means for reading the software code;
means for reading a test code having one or more test procedures adapted to test the software application based on one or more test methodologies, the test code further having one or more correlation tags, wherein the correlation tags each include one or both of the unique software component identifier associate with a component of the one or more components tested by the test code, and a test methodology;
means for compiling a second table based on the one or more correlation tags, wherein the second table identifies one or both of which of the one or more components are tested by each of the one or more test procedures and which of the one or more test methodologies are applied by each of the one or more test procedures, the means for compiling a second table responsive to the means for reading the test code; and
means for cross correlating the first table and the second table to determine one or more test metrics, the means for cross correlating responsive to the means for compiling a first table and the means for compiling a second table.

17. The system of claim 16, further comprising one or more of:
means for determining which components of the one or more components are not tested by the test code;
means for determining which components of the one or more components are tested more than once by the test code;
means for determining which test methodologies of the one or more test methodologies are applied to each component of the one or more components;
means for determining a source line of code ratio for each component of the one or more components; and
means for determining estimating one or more of a complexity and a costs of testing the software application.

18. A computer-readable medium having computer-executable instructions for performing a method for evaluating a test code, the method comprising
compiling a first table that comprises one or more unique software component identifiers associated with one or more components of a software application;
compiling a second table based on one or more correlation tags, wherein the second table identifies one or more of the one or more components of the software application tested by a test code, wherein the test code includes one or more test procedures adapted to verify the software application, and wherein the test code further includes the one or more correlation tags; and
cross correlating the first table and the second table to determine one or more test metrics.

19. The computer-readable medium of claim 18, wherein compiling the first table further comprises parsing the software application.

20. The computer-readable medium of claim 18, wherein compiling the second table further comprises parsing the test code based on the correlation tags.

21. The computer-readable medium of claim 18, wherein compiling the second table further comprises identifying within a first test procedure of the one or more test procedures a first unique software component identifier of the one or more unique software component identifiers associated with a first component of the one or more components.

22. The computer-readable medium of claim 21, wherein compiling the second table further comprises identifying a first test methodology of one or more test methodologies implemented by the first test procedure.

23. The computer-readable medium of claim 22, wherein identifying a first test methodology further comprises identifying one or more of, a min/max test methodology, a boundary test methodology, a stress test methodology, a permutation test methodology, an invalid value test methodology, a thread-safety test methodology, and a timing test methodology.

24. The computer-readable medium of claim 18, wherein compiling the second table further comprises identifying one or more test methodologies implemented by each of the one or more test procedures.

25. The computer-readable medium of claim 18, further comprising one or more of:
identifying untested components of the one or more components within the software application;
identifying components of the one or more components that are tested more than once by the test code;
identifying which test methodologies are applied to each of the one or more components;
determining a source line of code ratio for each component of the one or more components; and
determining one or both of a complexity and a costs of testing the software application.
